(19) United States
(12) Patent Application Publication
(10) Pub. No.: US 2012/0257548 A1
(43) Pub. Date: Oct. 11, 2012

(54) ACTIVE CODE SELECTION FOR JOINT-DETECTION BASED TDSCDMA RECEIVER

(76) Inventors: Aiguo Yan, Andover, MA (US); Hengsheng Tang, Beijing (CN); Yonggang Hao, Waltham, MA (US); Min Lei, Beijing (CN); Marko Kocic, Arlington, MA (US)

(21) Appl. No.: 13/109,009

(22) Filed: May 17, 2011

(30) Foreign Application Priority Data
Apr. 7, 2011 (CN) 201110086092.6

(51) Int. Cl. H04L 5/14; H04J 13/00

(52) U.S. Cl. 370/280

(57) ABSTRACT

A TD-SCDMA receiver includes a joint detector that receives an input signal from a transceiver. The joint detector analyzes the input signal to using an active code selection (ACS) to determine whether one or more neighboring cells are used in conjunction with a servicing cell. Also, the ACS assigns a first matrix that includes necessary active coded channels including those associated with the one or neighboring cells so as to formulate a channel matrix.

### BACKGROUND OF THE INVENTION

The invention is related to the field of Time Division Synchronous CDMA (TD-SCDMA), and in particular to active code selection for joint-detection based TD-SCDMA receiver.

Time Division Synchronous CDMA (TD-SCDMA) was proposed by China Wireless Telecommunication Standards group (CWTS) and approved by the ITU in 1999 and technology is being developed by the Chinese Academy of Telecommunications Technology and Siemens. TD-SCDMA uses the Time Division Duplex (TDD) mode, which transmits uplink traffic (traffic from the mobile terminal to the base station) and downlink traffic (traffic from the base station to the terminal) in the same frame in different time slots. That means that the uplink and downlink spectrum is assigned flexibly, dependent on the type of information being transmitted. When asymmetrical data like e-mail and internet are transmitted from the base station, more time slots are used for downlink than for uplink. A symmetrical split in the uplink and downlink takes place with symmetrical services like telephony.

### SUMMARY OF THE INVENTION

According to one aspect of the invention, there is provided a TD-SCDMA receiver. The TD-SCDMA receiver includes a joint detector that receives an input signal from a transceiver. The joint detector analyzes the input signal using an active code selection (ACS) to determine whether one or more neighboring cells are used in conjunction with a servicing cell. Also, the ACS assigns a first matrix that includes necessary active coded channels including those associated with the one or neighboring cells so as to formulate a channel matrix.

According to another aspect of the invention, there is provided a method of performing joint detection for coded channels associated with a TD-SCDMA receiver. The method includes receiving an input signal from a transceiver and analyzing the input signal using an active code selection (ACS) to determine whether one or more neighboring cells are used in conjunction with a servicing cell. Also, the method includes assigning a first matrix that includes necessary active coded channels including those associated with the one or neighboring cells so as to formulate a channel matrix.

### BRIEF DESCRIPTION OF THE DRAWINGS

FIG. 1 is a schematic diagram illustrating an exemplary embodiment of the invention;

FIG. 2 is a schematic diagram illustrating an abstract model of the TD-SCDMA used in accordance with the invention;

FIG. 3 is a flow chart illustrating the operations performed by the joint detector using the novel active code selection (ACS);

FIG. 4 is a schematic diagram illustrating the arrangement of an exemplary channel matrix T used in accordance with the invention; and

FIG. 5 is a schematic diagram illustrating the arrangement of exemplary channel matrices Tnew and To used in accordance with the invention.

### DETAILED DESCRIPTION OF THE INVENTION

The invention presents a novel technique allowing a joint detector to perform joint detection from signals received from either a serving cell or neighboring cells that possibly have equal power. The joint detector uses a novel active code selection (ACS) in dealing with signals being presented from neighboring cells and a servicing cell by re-ordering the matrix V in such a fashion to accommodate for neighboring cells.

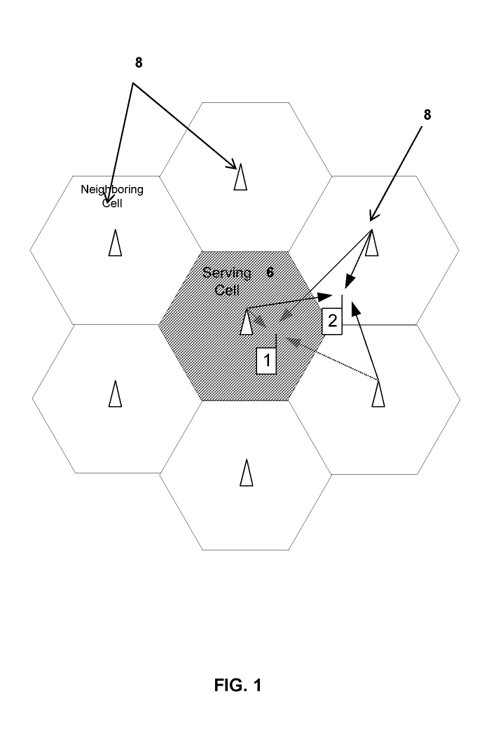

FIG. 1 is a schematic diagram illustrating the invention. TD-SCDMA systems use universal frequency reuse plan, i.e., neighboring cells 8 could immediately reuse the RF carrier frequencies which are used in the serving cell 6. Due to this reason, a handset 1, 2 could receive a signal which is a summation of signals from both serving and neighboring cells. The signal from neighboring cells 8 could also have comparable power levels as the signal from the serving cell 6.

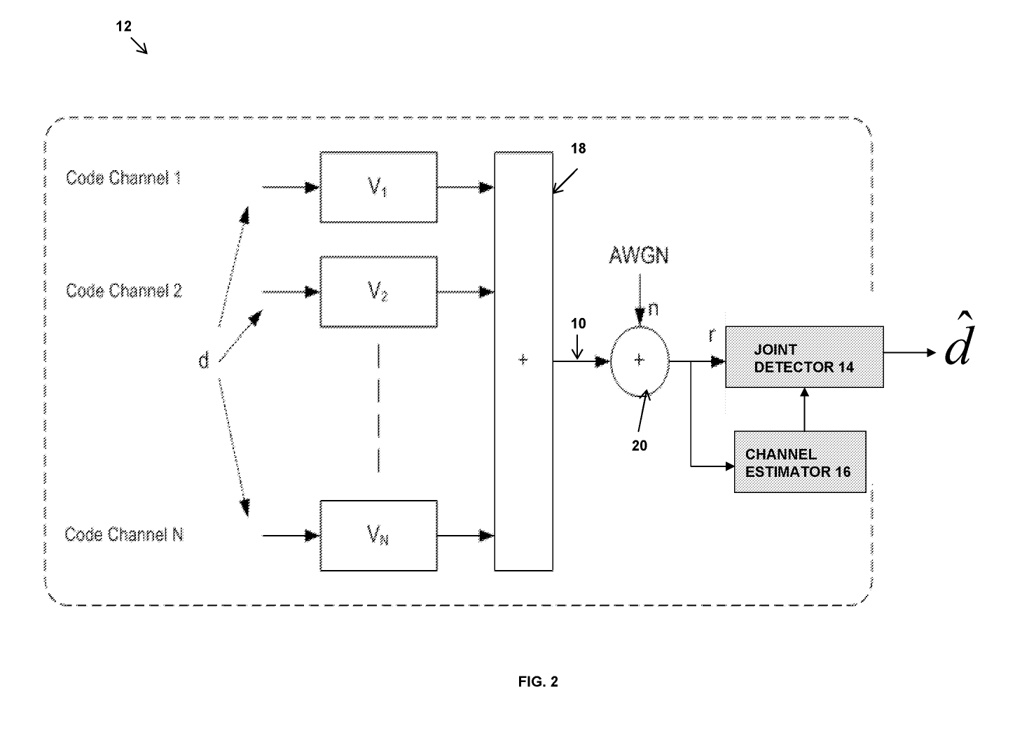

FIG. 2 is a schematic diagram illustrating an abstract model 12 of the TD-SCDMA used in accordance with the invention. A data symbol vector d is provided associated with data symbols from channels 1 . . . N. The values V₁ . . . V_{N} are elements of a matrix V that can define a channel matrix T, which is described further below. The values V₁ . . . V_{N} are combined using a first summation module 18. The first summation module 18 provides an output signal 10 to a second summation module 20. Note the output signal 10 has been processed by a transmitter and transmitted to a TD-SCDMA receiver which is then presented to the second summation module 20. The second summation module 20 adds the output signal 10 and a noise vector n, which defines noise in an AWGN associated with a TD-SCDMA receiver. The second summation module 20 provides an output signal r to a joint detector 14 and channel estimator 16. The channel estimator 16 provides an output signal 11 that sends information that aids the joint detector 14 to formulate a channel matrix T. The joint detector 14 receives the output signal r and performs the necessary processing to formulate an estimated data symbol vector \hat{d} using the novel active code selection (ACS). The active code selection (ACS) allows the joint detector 14 to arrange the matrix V as to allow a receiver to accommodate for signals coming from a serving cell or neighboring cells.

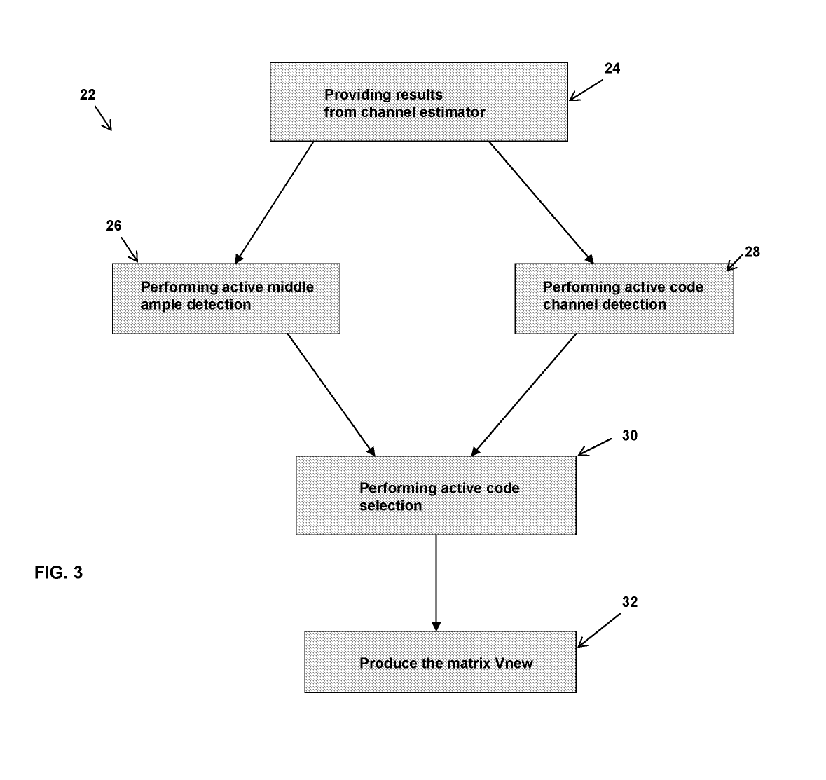

FIG. 3 is a flow chart 22 illustrating the operations performed by the joint detector 14 using the novel active code selection (ACS). As shown in step 24, the results of the channel estimator are provided to active middle ample detection (AMAD) and active code channel detection (ACCD). The AMAD performs and analyzes the results of the channel estimator to generate the matrix V associated with a received signal from a transceiver, as shown in step 26. The midample section of the received signal provides information to produce the matrix V. The ACCD analyzes the results of the channel estimator to determine the respective scaling factors and power levels of the elements V₁ . . . V_{N} of the matrix V, as shown in step 28. The joint detector performs ACS by receiving the results from the AMAD and ACCD to produce an appropriate matrix V for use in later processing in determining an appropriate channel matrix T, as shown in step 30. Based on these results, the joint detector determines whether in any given channel if a serving cell or neighboring cells is being used. If there is no neighboring cell, then values provided by the AMAD and ACCD can be used to directly produce the matrix V using known standard techniques in the art. However, if it is determined one or more neighboring cells are being used, the novel ACS produces a matrix V_{new} indicative of the neighboring cells and serving cells being used by a handset, as shown in step 32. The matrix V_{new} can then be used to produce the channel matrix T_{new} allowing for better estimation of the data symbols received by a TD-SCDMA receiver by neighboring cells and a servicing cell. The ACS utilizes special properties and relationships to further aid in determining which code channels are best for throughput.

The output signal r can have the following matrix relation:

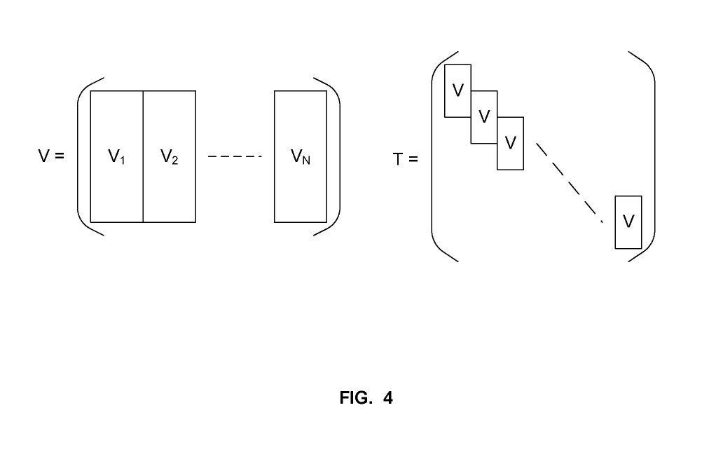

r=Td+n (1)

where the matrix T defines a channel matrix and the matrix d defines a matrix associated with the input data symbols. The matrices T and V have the following structure, after active code channel detection (ACD) and active middle amble detection (AMD), as shown in FIG. 4.

The invention uses an MMSE joint detection solution defined as:

(T^{H}T+σ²I)\hat{d}_{MMSE}=T^{H}r (2)

where \hat{d} defines the estimated data symbol vector outputted by the joint detector.

Many times, one may also want to use the Zero-Forcing JD (ZF-JD) to provide a approximation for \hat{d}, which can simplify the computation, which is defined as:

(T^{H}T)\hat{d}_{ZF}=T^{H}r (3)

where \hat{d}_{ZF} defines the estimated data symbol vector produced using ZF-JD.

In order to get a unique solution which is also insensitive to small approximation errors in any practical implementation, the matrix B=T^{H}T needs to be invertible (i.e. full rank) and have a small condition number. The matrix A=(T^{H}T+σ²I) is guaranteed to be invertible (i.e. full rank) but not guaranteed to have a small condition number.

Due to the structure of the matrix T, its rank and condition number are uniquely decided by the matrix V. When the matrix V has full rank it will automatically guarantee that channel matrix T has full rank as well.

If V₁ to V_{N} are all from the same cell, then matrix V can in general have a full rank. However, if V₁ to V_{N} are from different cells, one cannot guarantee full rank of the matrix V.

In this case, one would need to decompose the matrix V into matrices V_{new} and Vₒ so that: 1) the matrix V_{new} has full rank and B_{new}=T_{new}^{H}T_{new} has a small condition number and 2) the matrix V_{new} includes all required code channels intended to be assigned to the handset, where the matrix V_{new} is defined as

$$r = Td + n = {T}_{new} {d}_{new} + {\underbrace{{T}_{o} {d}_{o} + n}}_{w} = {T}_{new} {d}_{new} + w \qquad ( 4 )$$

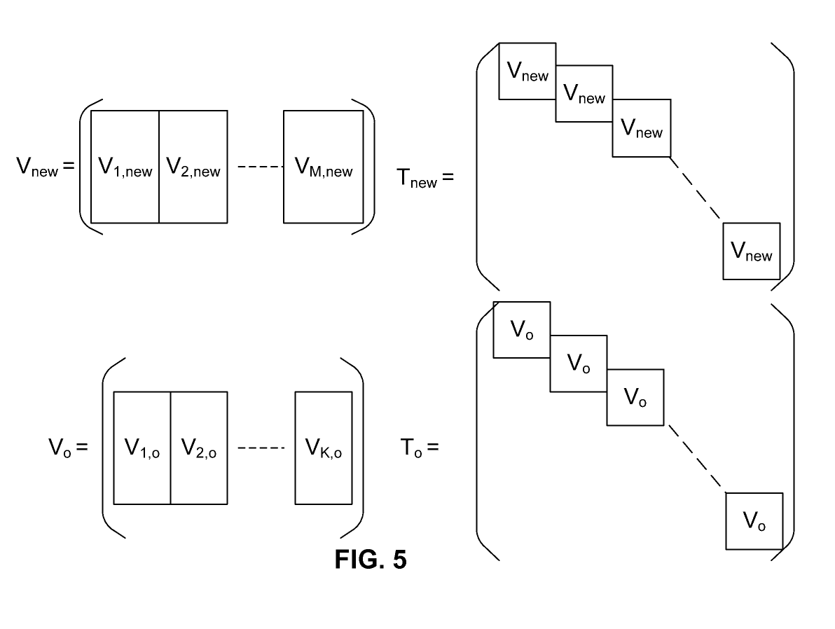

FIG. 5 illustrates the arrangement of the matrices V_{new}, T_{new}, Vₒ, and Tₒ. Target 1) and 2) are reached with the aid of ACS. In particular, ACS keeps all code channels intended for desired UE and removes those neighboring cells' code channels that will reduce the condition number of matrices V_{new} significantly. There are many possible ways to implement ACS. For example, the decomposition of V into V_{new} and Vₒ can be easily accomplished with help of the standard Gram-Schmidt procedure.

Then the final JD solution after ACS is:

(T_{new}^{H}T_{new}+σ_{w}²I)\hat{d}_{new}=T_{new}^{H}r (4)

In fact, we can see from this equation that only V_{new} is required to build in practical realization.

Since both matrices A=(T^{H}T+σ²I) and B=T^{H}T are Hermitian (i.e., A^{H}=A), there exists a unitary (P^{H}P=I) matrix P such that P^{H}(T^{H}T+σ²I)P=diag[λ₁+σ²λ₂+σ² . . . λₖ+σ² . . . λ_{M}+σ²] with all λ≧0 and

$$det ( A ) = det ( {T}^{H} T + {σ}^{2} I ) = {\prod }_{i = 1}^{M} ( {λ}_{i} + {σ}^{2} )$$

where λᵢ is the eigen-value of the matrix B.

Since noise power is normally very small, any small Eigen-value λᵢ would make det(A) small. With 2-NORM (∥ ∥₂) the condition number of the matrix A is

$$κ ( A ) = \frac{max ( λ ( A ) )}{min ( λ ( A ) )} = \frac{{σ}^{2} + max ( λ ( B ) )}{{σ}^{2} + min ( λ ( B ) )}$$

in this case.

The ratio,

$$κ ( A ) = \frac{max ( λ ( A ) )}{min ( λ ( A ) )} ,$$

is one of the indicators for the difficult of the practical implementation of the JD algorithm. When the ratio is bigger, the numerical stability is going to be poorer and wider data path would be required.

In one aspect, joint detection in general increases BER/BLER/throughput performance. One can jointly detect as many code channels as possible including those code channels that could result in bigger condition numbers, which can be practically very expensive and potentially catastrophic. The objective of ACS is to balance these 2 conflicting requirements. Also, the ACS can be used in either 2× or 1× JD with single-cell or multi-cell scenarios.

Although the present invention has been shown and described with respect to several preferred embodiments thereof, various changes, omissions and additions to the form and detail thereof, may be made therein, without departing from the spirit and scope of the invention.

What is claimed is:

1. A TD-SCDMA receiver comprising a joint detector that receives an input signal from a transceiver, the joint detector analyzes the input signal using an active code selection (ACS) to determine whether one or more neighboring cells are used in conjunction with a servicing cell, ACS assigns a first matrix that includes necessary active coded channels including those associated with the one or neighboring cells so as to formulate a channel matrix.

2. The TD-SCDMA receiver of claim 1, wherein the joint detector analyzes the middle ample data of the input signal to form the first matrix.

3. The TD-SCDMA receiver of claim 1, wherein the joint detector uses active code channel detection to assign power levels to the elements of the first matrix.

4. The TD-SCDMA receiver of claim 1, wherein the joint detector uses active middle ample detection to determine the one or more neighboring cells.

5. The TD-SCDMA receiver of claim 1, wherein the joint detector comprises 1× or 2× joint detection.

6. The TD-SCDMA receiver of claim 1, wherein the joint detector uses MMSE or Zero-Forcing joint detection to determine an estimated data symbol.

7. The TD-SCDMA receiver of claim 1, wherein the joint detector formulates the first matrix to have full rank as well as the channel matrix.

8. The TD-SCDMA receiver of claim 1, wherein the ACS determines which active code channel from neighboring cells are to be processed by JD, so that the first matrix has a small condition number and is insensitive to small approximations errors.

9. The TD-SCDMA receiver of claim 1, wherein the condition number of the channel matrix is uniquely decided by the first matrix.

10. A method of performing joint detection for coded channels associated with a TD-SCDMA receiver comprising:
receiving an input signal from a transceiver;
analyzing the input signal using an active code selection (ACS) to determine whether one or more neighboring cells are used in conjunction with a servicing cell; and
assigning a first matrix that includes necessary active coded channels including those associated with the one or neighboring cells so as to formulate a channel matrix.

11. The method of claim 10, wherein the analyzing the input signal step comprises analyzing the middle ample data of the input signal to form the first matrix.

12. The method of claim 1, wherein the assigning a first matrix step comprises assigning power levels to the elements of the first matrix.

13. The method of claim 10, wherein the analyzing the input signal step comprises using active middle ample detection to determine the one or more neighboring cells.

14. The method of claim 10, wherein the TD-SCDMA receives comprises 1× or 2× joint detection.

15. The method of claim 10, wherein the assigning a first matrix step comprises using MMSE or Zero-Forcing joint detection to determine an estimated data symbol.

16. The method of claim 10, wherein the assigning a first matrix step comprises formulating the first matrix to have full rank as well as the channel matrix.

17. The method of claim 10, wherein the ACS determines which active code channel from neighboring cells are to be processed by JD, so that the first matrix has a small condition number and is insensitive to small approximations errors.

18. The method of claim 10, wherein the condition number of the channel matrix is uniquely decided by the first matrix.
